(19) United States
(12) Patent Application Publication
(10) Pub. No.: US 2015/0317464 A1
(43) Pub. Date: Nov. 5, 2015

(54) Selective Infrared Filtering for Imaging-Based User Authentication and Visible Light Imaging

(71) Applicant: Motorola Mobility LLC, Chicago, IL (US)

(72) Inventors: Lawrence A. Willis, McHenry, IL (US); John C. Johnson, Spring Grove, IL (US); Jiri Slaby, Buffalo Grove, IL (US)

(73) Assignee: Motorola Mobility LLC, Chicago, IL (US)

(21) Appl. No.: 14/265,454

(22) Filed: Apr. 30, 2014

(51) Int. Cl. G06F 21/32; G06K 9/00; H04N 5/33

(52) U.S. Cl. CPC G06F 21/32; H04N 5/332; G06K 9/00604; G06K 9/00617

(57) ABSTRACT

A device (100) includes an infrared light source (114), an imaging sensor (212), and an electrochromic filter (214) overlying the imaging sensor. The electrochromic filter is configurable between at least a first filter state and a second filter state, whereby the second filter state has a higher infrared light transmittance than the first filter state. The device further includes a controller (314) to reconfigure the electrochromic filter from the first filter state to the second filter state responsive to a user authentication event. The device further may include a processing component (302) to trigger the infrared light source to emit infrared light and to process an infrared light image captured by the imaging sensor, the infrared light image including a reflection of the emitted infrared light. The processing component may process the infrared light image by performing a user recognition process using the infrared light image.

### FIELD OF THE DISCLOSURE

The present disclosure relates generally to image capture and processing and more particularly to user authentication using captured imagery.

### BACKGROUND

Near infrared (NIR) light often is used in conjunction with an imaging camera to capture certain user features for user recognition purposes. Conventional devices providing such recognition functionality typically incorporate two imaging cameras, one imaging camera for visible light imaging (e.g., normal photo capture and video capture) and an NIR imaging camera for user recognition purposes. This dual-camera approach results in excessive cost, complexity, size, and power consumption for such devices.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram illustrating a user device employing an imager with selective infrared (IR) filtering in accordance with at least one embodiment of the present disclosure.

FIG. 2 is a diagram illustrating a cross-sectional view of the example user device of FIG. 1 in accordance with at least one embodiment of the present disclosure.

FIG. 3 is a diagram illustrating an example system implementation of the user device of FIG. 1 in accordance with at least one embodiment of the present disclosure.

FIG. 4 is a flow diagram illustrating an example method for selective IR filtering responsive to user authentication events at a user device in accordance with at least one embodiment of the present disclosure.

FIG. 5 is a flow diagram illustrating an example method for detecting and verifying a user authentication event for the method of FIG. 4 in accordance with at least one embodiment of the present disclosure.

### DETAILED DESCRIPTION

The following description is intended to convey a thorough understanding of the present disclosure by providing a number of specific embodiments and details involving selective IR light filtering at an imager of a device based on user authentication events. It is understood, however, that the present disclosure is not limited to these specific embodiments and details, which are examples only, and the scope of the disclosure is accordingly intended to be limited only by the following claims and equivalents thereof. It is further understood that one possessing ordinary skill in the art, in light of known systems and methods, would appreciate the use of the invention for its intended purposes and benefits in any number of alternative embodiments, depending upon specific design and other needs.

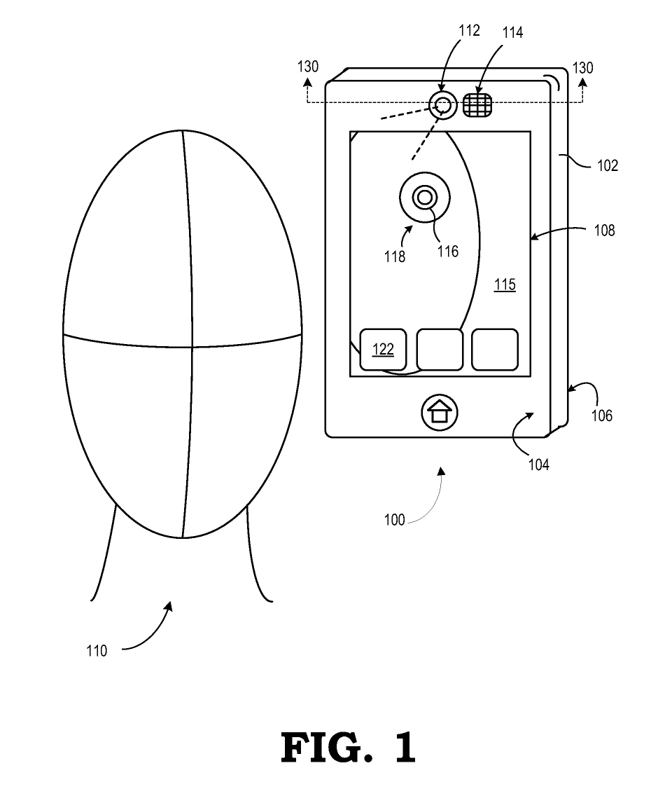

FIGS. 1-5 illustrate example techniques for selective IR light filtering at an electronic device so as to permit a single imaging sensor of an imager of the device to support both visible light image capture for normal imaging purposes and IR light image capture for user recognition purposes. In at least one embodiment, the electronic device employs an imager having an imaging sensor and an electrochromic filter overlying the imaging sensor, whereby the electrochromic filter implements at least two electrically-controlled filter states: an infrared blocking state to block IR light and permit visible light transmittance; and an infrared transmitting state that permits IR light transmittance. The electrochromic filter may implement, for example, a bi-stable nanocrystal film that changes between a relatively high near infrared (NIR) transmittance state and a relatively low NIR transmittance state according to the particular voltage level applied to the film. In situations where the primary use of the imager typically is visible light imaging, the electrochromic filter may be configured by default to the infrared blocking state. In response to a user authentication event that relies on imagery-based user recognition, the electronic device may emit an IR flash from an IR light source and concurrently reconfigure the electrochromic filter to the infrared transmitting state so as to capture an IR light image that represents a reflection of the IR flash from the user's face. After capturing this IR light image, the electrochromic filter may be returned to the IR blocking filter state and the captured IR light image may be processed for user recognition and authentication. By using an electrochromic filter, the electronic device may support both visible light imaging applications and NIR light imaging applications using a single imaging sensor.

The user authentication event that triggers the temporary switch of the electrochromic filter to the IR transmitting state may include any of a variety of events that relate to a user's attempt to access certain functionality of the electronic device. In implementations where the electronic device is a personal device such as a smartphone or mobile computer, examples of such include a user's attempt to gain access past a “start” screen or “passcode” screen or to gain access to a particular software application or feature of a software application. Other examples of user authentication events can include attempts to gain access to secured information, including a secured room or building, secured information local to the electronic device, or secured information remotely stored in a network. For example, a user's attempt to conduct a commercial transaction using a particular credit card or bank account having a record on the electronic device may be interpreted as a user authentication event, as may a user's attempt to access a bank account or other type of account via a website or other interface hosted by a remote server. Such access attempts are not limited to commercial accounts or commercial transactions. Access to non-commercial accounts, such as email accounts or social media accounts, likewise may be interpreted as user authentication events and thus triggers the image-based user authentication process described herein.

NIR light typically is the subspectrum of IR light used for user recognition due to its reflective properties and relatively low attenuation losses in silicates and other common optics media. Accordingly, the techniques of the present disclosure are described in the example context of using NIR light for user recognition. However, the techniques described herein are not limited to NIR light, and instead may be implemented using light from other subspectrums of the IR spectrum, such as short wavelength infrared (SWIR) light. As such, NIR and IR are used interchangeably herein unless otherwise noted. Moreover, for ease of description, iris-based user recognition techniques are referenced by example in the following. However, the techniques described herein are not limited to iris-based analysis, but instead may utilize any of a variety of user recognition techniques based on IR light imagery, including facial recognition techniques such as eye vein analysis techniques, general vein analysis techniques, facial feature extraction techniques and skin texture analysis techniques.

FIG. 1 illustrates an example user device 100 employing a dual-use imager for capturing both visible light imagery and IR light imagery. The user device 100 can include any of a variety of portable and non-portable electronic devices operated by one or more users and employing imagery-based functionality, such as a tablet computer, computing-enabled cellular phone (e.g., a “smartphone”), a notebook computer, a personal digital assistant (PDA), a gaming system, a television system, set-top box, personal or enterprise security system, drone control system, and the like. For ease of illustration, the user device 100 is generally described herein in the example context of a portable user device, such as a tablet computer or a smartphone; however, the user device 100 is not limited to these example implementations.

In the depicted example, the user device 100 includes a housing 102 having a side 104 opposite another side 106. In the example thin rectangular block form-factor depicted, the sides 104 and 106 are substantially parallel and the housing 102 further includes four other side surfaces (top, bottom, left, and right) between the side 104 and side 106. The housing 102 may be implemented in many other form factors, and the sides 104 and 106 may have a non-parallel orientation. For the illustrated tablet implementation, the user device 100 includes a display 108 disposed at the side 104 for presenting visual information to a user 110. Accordingly, for ease of reference, the side 106 is referred to herein as the “forward-facing” surface and the side 104 is referred to herein as the “user-facing” surface as an indication of this example orientation of the user device 100 relative to the user 110, although the orientation of these surfaces is not limited by these relational designations.

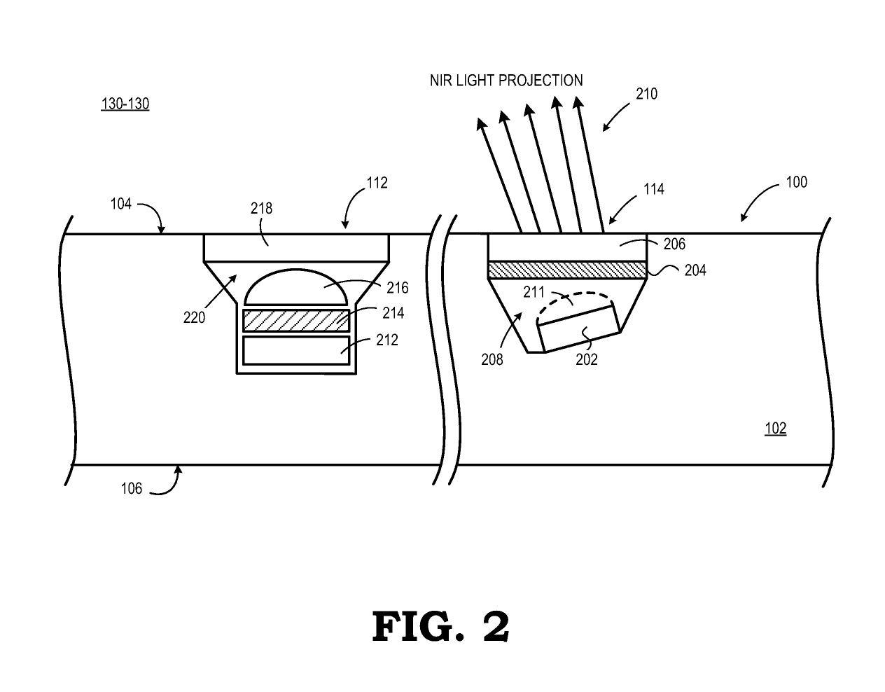

In the depicted example, the user device 100 implements an imager 112 and an IR light source 114 disposed at the user-facing side 104. The IR light source 114 can include any of a variety of devices used to emit NIR light, such an infrared light emitting diode (LED), or a broad-spectrum LED and an IR pass filter that substantially attenuates non-NIR light emitted by the broad-spectrum LED. As illustrated in greater detail below in FIG. 2 with reference to a cross-section view along cutline 130-130, the imager 112 includes an imaging sensor and an electrochromic filter overlying the imaging sensor, whereby the electrochromic filter can be electrically controlled to operate in an IR blocking filter state whereby IR light is substantially attenuated, or “blocked”, by the electrochromic filter, and an IR transmitting filter state whereby IR light is substantially transmitted through the electrochromic filter. The electrochromic filter may be implemented as, for example, a filter employing an electrically-controlled nanocrystal-in-glass structure.

In operation, the user device 100 can utilize the imager 112 in at least two modes: a visible light mode and an IR light mode. In the visible light mode, the user device 100 configures the imager 112 so that the electrochromic filter is placed in the IR blocking filter state so that the imaging sensor can be used to capture imagery based on incident electromagnetic energy primarily in the visible-light spectrum (referred to herein as a “visible light image” or “visible light imagery”). For example, the user device 100 may configure the imager 112 into the visible light mode so as to support use of the imager 112 for typical user-initiated imagery functionality, such as user-initiated video or still-image photography via the imager 112, video conferencing via the imager 112, and the like. The visible light imagery captured while in this mode may be displayed at the display 108, analyzed or otherwise processed by the user device 100 (e.g., for visual telemetry purposes), transmitted to a remote server for further processing, transmitted to a remote device for display, and the like. In the IR light mode, the user device 100 configures the imager 112 so that the electrochromic filter is placed in the IR transmitting filter state so that the imaging sensor can be used to capture imagery based on incident electromagnetic energy primarily in the NIR spectrum (referred to herein as an “infrared image” or “infrared imagery”). The capture of an infrared image typically is initiated by a brief emission of NIR light by the IR light source 114 (that is, an “IR flash”), and the infrared image captured by the imager 112 thus is intended to be the capture of a reflection of the emitted IR light.

In at least one embodiment, the infrared imagery captured while the imager 112 is in the IR light mode is used to support user recognition analysis by the user device 100 or by a remote system for purposes of authenticating the user for access to secured information, for access to protected functionality, or to conduct certain transactions via the user device, such as an electronic commerce transaction. Accordingly, in some embodiments, the user device 100 is configured by default to employ the imager 112 in the visible light mode, and when the user device 100 detects a user authentication event that involves authorization via an imagery-based user recognition process, the user device 100 responds by temporarily reconfiguring the imager 112 into the IR light mode for purposes of capturing infrared imagery in support of this user recognition and authentication process. In many instances, the user recognition process relies on an infrared image 115 capturing an iris 116 of an eye 118 of the user 110, and thus the imager 112 is configured so as to enable capture of the infrared image 115. This configuration can include, for example, configuration of one or more lenses of the imager 112 so as to permit the imager 112 to focus at the expected distance between the iris 116 of the user 110 and the imager 112 while the user device 100 is in use by the user 110, as well as an optical or digital zoom feature to allow the captured infrared image to primarily include the iris 116.

User authentication events triggering the switch to the IR light mode typically are detected via user interaction with the user device 100. To illustrate, a user authentication event may be detected as an attempt by the user 110 to access functionality of the user device 100, such as an attempt to gain general access to the user device 100. For example, the user device 100 may be configured to present a “passcode” screen on the display 108 after exiting a sleep mode, and the user's attempt to gain access to the “home” screen of the user device 100 past this passcode screen (via the user's manipulation of a hard button 120 of the user device 100, for example) may be interpreted as a user authentication event. As another example, the launching of a software application may be initiated via user selection of an icon 122 displayed at the display 108, and the user's attempt to gain general access to this software application via the user's interaction with the icon 122 may be interpreted as a user authentication event. As yet another example, a software application may have certain sensitive or limited-use functionality, and the user's attempt to access this functionality (such as by selecting a feature related to this functionality) may be interpreted as a user authentication event.

A user authentication event also may be detected as an attempt to gain access to secured information via the user device 100, such as while conducting an electronic commerce transaction using the user device 100. This secured information may be local secured information; that is, secured information stored locally at the user device 100. To illustrate, bank account information or other account information for an account associated with a user may be stored at the user device 100, and an attempt by the user 110 to access this account information, or use this account information in some way, may be interpreted as a user authentication event. The secured information instead may be remote secured information; that is, secured information stored remotely at a server or other remote system connected to the user device 100 via one or more wireless or wired networks. To illustrate, the user 110 may utilize a web browser of the user device 100 to purchase an item from the website of a retailer, and the user's attempt to access credit card information maintained by the retailer to pay for the item may be interpreted as a user authentication event.

As the imager 112 supports capture of both visible light imagery and IR light imagery, the imager 112 serves dual purposes in supporting both normal user imagery capture and imagery capture for user recognition and authentication. Moreover, because the imager 112 employs a electrochromic filter to enable this dual-purpose functionality, a single imaging sensor may be used for both roles, and thus the user device 100 may employ a smaller form factor and be implemented with reduced complexity and power consumption compared to conventional devices that implement two separate imaging sensors to provide both visible light imagery capture and infrared light imagery capture, and compared to devices that implement a mechanical filter that mechanically swaps out two different filters to provide the same dual functionality.

FIG. 2 illustrates a partial cross-section view of the user device 100 along the cutline 130-130 (see FIG. 1) in accordance with at least one embodiment. As depicted, the user device 100 includes the imager 112 and the IR light source 114 disposed at the user-facing side 104 of the housing 102. Although not shown in FIG. 2, the user device 100 further may include a second imager disposed at the forward-facing side 106 of the housing 102, which may be used for visible-light image and video capture, visual-based telemetry purposes, and the like.

In this example implementation, the IR light source 114 includes one or more LEDs 202, a visually-opaque/IR transparent optical filter 204, and a surface lens 206 disposed in a cavity 208. The optical filter 204 overlies the one or more LEDs 202 and serves to transmit an IR component of light emitted by the one or more LEDs 202 while blocking the visible component of the emitted light. Further, because the optical filter 204 is visually opaque, the optical filter 204 also may serve to mask the opening of the cavity 208. The surface lens 206 overlies the optical filter 204 and protects the optical filter 204 from damage. The surface lens 206 may be implemented using one or a combination of materials, such as silicate (glass), sapphire, plastic, and the like. Because the IR light source 114 is laterally offset from the imager 112, the IR light source 114 may be configured so that IR light 210 projected by the IR light source 114 is angled such that the anticipated reflection of the IR light 210 from a user's face is primarily directed toward the imager 112. As illustrated in FIG. 2, this angling may be achieved by angling the one or more LEDs 202 relative to the plane of the side 104. Alternatively, this angling may be achieved using a lens 211 overlying the LED 202.

As also illustrated by the depicted cross-section view, the imager 112 includes an imaging sensor 212, an electrochromic filter 214, a sensor lens 216, and surface lens 218 disposed in a cavity 220 at the side 104 of the user device 100. The imaging sensor 212 can include any of a variety of imaging sensors, such as a charge coupled device (CCD)-type imaging sensor or a complementary metal oxide semiconductor (CMOS)-type imaging sensor for sensing electromagnetic energy in both the visible-light and NIR subspectrums. The electrochromic filter 214 and sensor lens 216 overlie the imaging sensor 212. In the depicted example, the electrochromic filter 214 directly overlies the imaging sensor, with the electrochromic filter 214 disposed between the imaging sensor 212 and the sensor lens 216. In other embodiments, the electrochromic filter 214 overlies the imaging sensor 212 with the sensor lens 216 disposed in between the two. As with the surface lens 206 of the IR light source 114, the surface lens 218 protects the imager 112 and may be composed of silicate, sapphire, plastic, and the like. The surface lens 206 is optically transparent to both visible light and infrared light. In some embodiments, the surface lens 206 and the surface lens 218 are implemented by the same piece of material, such as by a front glass panel that covers a portion of the user-facing side 104 of the user device 100.

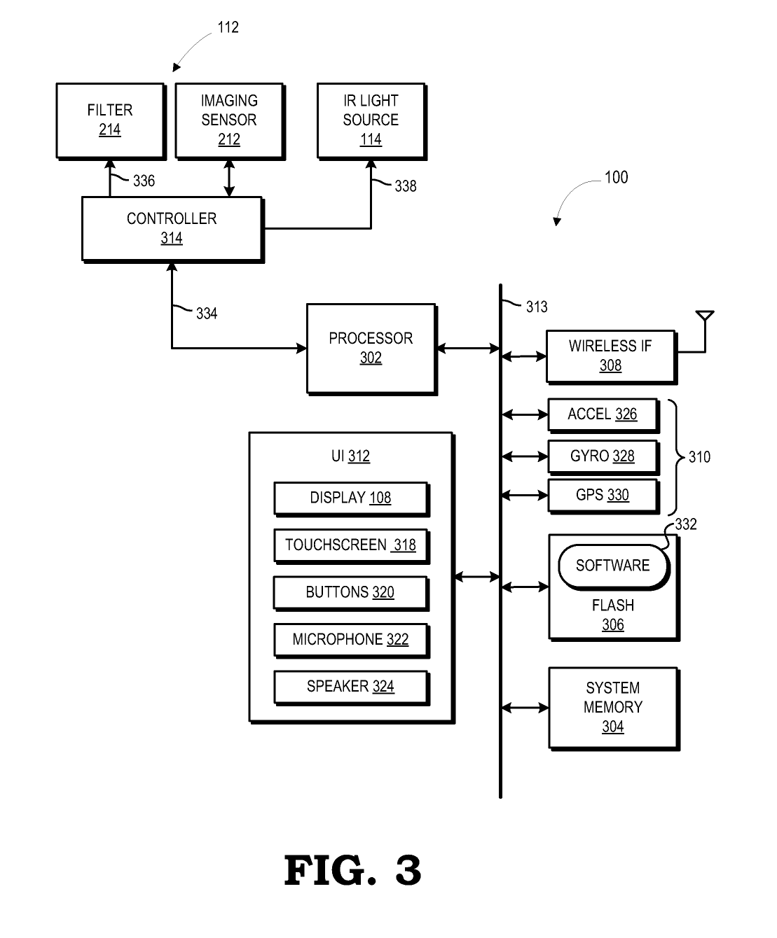

The electrochromic filter 214 selectively employs the IR blocking filter state (that is, having a low IR light transmittance) and the IR transmitting filter state (that is, having a high IR light transmittance) in support of the visible light mode and IR light mode, respectively. To this end, the electrochromic filter 214 is electrically controlled to a selected one of the IR blocking filter state or the IR transmitting filter state via different voltage levels (not shown in FIG. 2) applied to the electrochromic filter 214 by a controller (FIG. 3) of the user device 100. To provide this functionality, the electrochromic filter 214 may be implemented using an electrically-switched bistable electrochromic filter providing both a high IR light transmittance state and a low IR light transmittance state.

To illustrate, the electrochromic filter 214 may include an electrochromic filter implementing a nanocrystal-in-glass film or other amorphous metal oxide suspended in glass film that provides IR transparency (and visible light transparency) when one voltage level is applied to the film and IR opacity (and visible light transparency) when a different voltage level is applied. An example of the nanocrystal-in-glass film is a film constructed tin (Sn)-doped indium oxide (In₂O₃) (ITO) nanocrystals suspended in a niobium oxide (NbOₓ) glass. For such ITO-in-NbOₓ films, it has been found that NIR light transmittance of 90% or greater (e.g., a high IR light transmittance) can be obtained from application of a voltage of at least 3 volts (3V) and that NIR light transmittance of 20% or less (e.g., a low IR light transmittance) can be obtained from application of a voltage of 1.5 V or less. Thus, an implementation of the electrochromic filter 214 employing an ITO-in-NBOₓ film with such properties may be configured to the IR blocking filter state by applying a voltage of 1.5 V or less (e.g., 0 V) and configured to the IR transmitting filter state by applying a voltage of 3 V or more (e.g., 4 V).

FIG. 3 illustrates an example hardware implementation of the user device 100 for operation and control of the imager 112 and IR light source 114 in accordance with at least one embodiment. As illustrated, the user device 100 includes one or more processors 302 (e.g., a central processing device or CPU) or other processing component, one or more memories, such as system memory 304 and flash memory 306, a wireless interface 308, a set 310 of sensors, and a user interface (UI) 312 connected via one or more busses 313 or other interconnects. The user device 100 further includes a controller 314 to control the imaging sensor 212 and the electrochromic filter 214 of the imager 112, as well as to control the IR light source 114.

The UI 312 receives input from the user 110 (FIG. 1), as well as provides information and other signaling to the user 110, and thus may include, for example, the display 108 or other display component, a touch screen 318 (integrated with, for example, the display 108) or other touch panel, one or more hard buttons 320, a microphone 322, a speaker 324, and the like. The set 310 of sensors includes one or more sensors utilized by the user device 100 to support its operation. Examples of such sensors can include an accelerometer 326, a gyroscope 328, and a global positioning system (GPS) receiver 330, as well as the microphone 322, the touchscreen 318, and the hard buttons 320 of the UI 312. As described below, feedback from one or more of these sensors may be used to reduce or eliminate false detection of user authentication events at the user device 100.

The controller 314 may be implemented as hard-coded logic, as the processor 302 executing software, or a combination thereof. To illustrate, the controller 314 may be implemented as a field programmable gate array (FPGA) or application specific integrated circuit (ASIC) that receives signaling 334 from the processor 302 and operates to control the imager 112 and IR light source 114 accordingly. Alternatively, the controller 314 may be implemented with the processor 302 executing a set of instructions stored at one or more non-transitory computer readable media, such as the flash memory 306, the system memory 304, or a hard drive (not shown). The set of instructions represents a software application 332 (or multiple software applications 332), which manipulates the processor 302 to perform various software-based functionality to implement at least a portion of the techniques described herein, provide visual information via the display 108, respond to user input via the user interface 312, and the like.

The controller 314 functions to control the capture of imagery via the imaging sensor 212, including the transmission of control signaling to the imaging sensor 212 to initiate an image capture as well as the reception of data signaling from the imaging sensor 212 to receive image data representing an image captured by the imaging sensor 212. To enter the visible light mode, the processor 302 signals a mode switch to the controller 314 using control signaling 334. In response, the controller 314 supplies a particular voltage as voltage signaling 336 to the electrochromic filter 214 so as to configure the electrochromic filter 214 to the IR blocking state having a low IR transmittance. Accordingly, any light incident on the imaging sensor 212 through the electrochromic filter 214 is primarily electromagnetic energy from the visible light spectrum, and thus imagery captured by the imaging sensor 212 in this mode is visible light imagery suitable for display at the display component 108 or local storage as a photo image or video, or suitable for transmission to a remote device, such as in support of a video teleconference.

To enter the IR light mode (in response to, for example, a user authentication event), the processor 302 signals the mode switch to the controller 314 using the control signaling 334, in response to which the controller 314 supplies a different voltage as voltage signaling 336 to the electrochromic filter 214. This other voltage configures the electrochromic filter 214 to the IR transmitting state having a high IR transmittance. The controller 314 then may initiate the capture of an IR light image by triggering the emission of an IR flash by the IR light source 114 using control signaling 338 and then capturing a reflection of the IR flash (as well as other incident IR light present) at the imaging sensor 212 through the electrochromic filter 214. The processor 302 may trigger this IR light image capture process by, for example, detecting the presence of a user's face, or more particularly a user's iris, in a target area via the imager 112, through a user's instruction to capture the IR light image (e.g., through user manipulation of a hard button 320 or a soft button displayed at the display 108), and the like. As described in greater detail below, the resulting IR light image then may be used for user recognition analysis in support of an effort to authenticate the user for purposes of accessing secured information or conducting certain transactions via the user device 100.

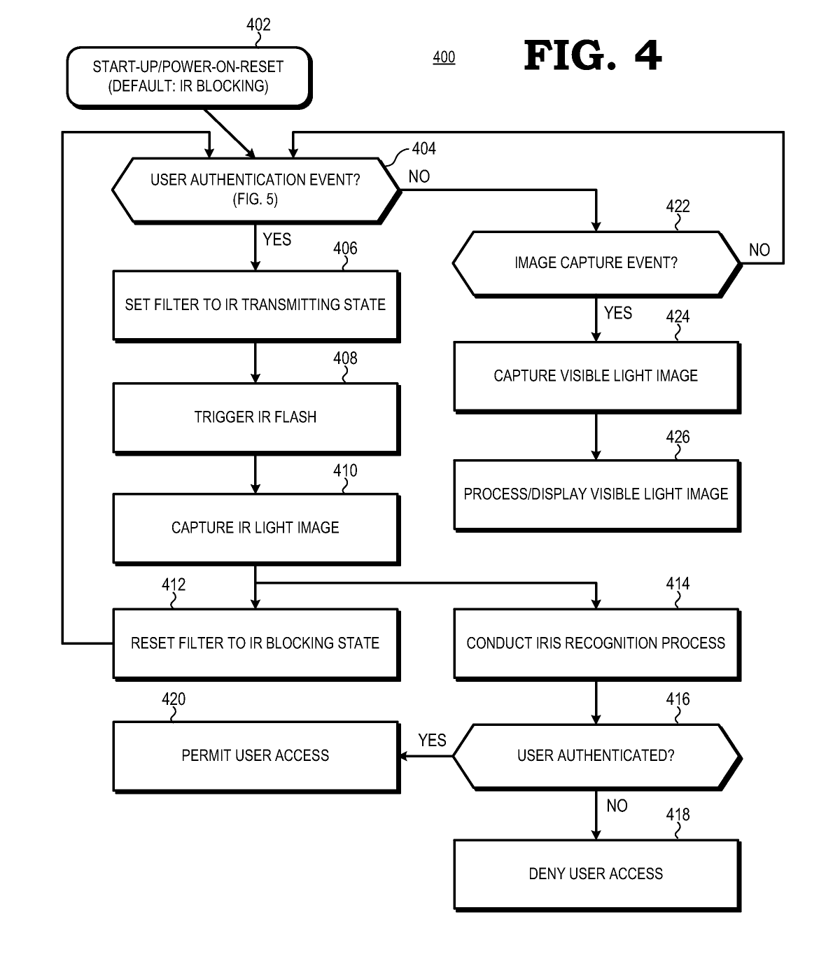

FIG. 4 illustrates an example method 400 for dual-purpose utilization of the imager 112 of the user device 100 in support of both visible light image capture and imagery-based user recognition and authentication in accordance with at least one embodiment. Typically, the user device 100 is configured by default for visible light image capture, and thus in response to a start-up event, power-on-reset event or other reset event, the user device 100 configures the controller 314 to the visible light mode by default at block 402. As noted above, this includes applying a select voltage to the electrochromic filter 214 as the voltage signaling 336 so as to configure the electrochromic filter 214 into the IR blocking filter state.

At block 404, the processor 302 monitors the operation of the user device 100 in order to detect a user authentication event. A user authentication event can include, for example, a user's manipulation of the user device 100 in a manner that triggers a user authentication process that is based on image-based recognition of the user. Such triggers typically include an attempt to access secured information stored either locally at the user device 100 or stored remotely at, for example, a remote server that is connected to the user device 100, or an attempt to access certain functionality of the user device 100 or of a software application supported at the user device 100.

To illustrate, a user may manipulate a graphical user interface (GUI) provided by the user device 100 to attempt to access bank account information stored locally at the user device 100, and this access attempt would trigger a user authentication process to authenticate the user as having permission to access the bank account information before doing so. As another example, the user may attempt to pay a bill or make a purchase via a website displayed at the user device 100, and the remote server that is facilitating the website transaction may request user authentication such as via an iris scan before permitting the transaction to proceed. As a further example, the user may attempt to access a home screen of the user device 100, and this may trigger the need for user authentication based on image-based user recognition in addition to, or instead off, entry of a passcode at a passcode screen of the GUI provided by the user device 100. A user's attempt to access a certain software application, or certain functionality within the software application, also may trigger a user authentication process and thus be interpreted as a user authentication event.

In response to detecting a user authentication event, at block 406 the user device 100 enters the IR light mode in anticipation of initiation of the process of capturing an IR light image of the user's iris or other features of the user for user recognition purposes. As part of this mode switch, the controller 314 temporarily reconfigures the electrochromic filter 214 to the IR transmitting filter state by providing a select voltage as the voltage signal 336, which in turn reconfigures the electrochromic filter 214 to have a high IR light transmittance, as discussed above. With the electrochromic filter 214 reconfigured, at block 408 the controller 314 triggers the IR light source 114 to emit an IR flash. As the IR flash typically is not visible to the user, the IR flash may be triggered without explicit control of the user, such as by analyzing the imagery coming in from the imaging sensor 212 to detect the presence of the user's iris, and when detected, automatically triggering the IR flash. Alternatively, the user device 100 may seek explicit input from the user before triggering the IR flash, such as by allowing the user to position the user's eye in front of the imager 112 and then triggering the IR flash via a hard button or soft button when ready. As yet another alternative, the user device 100 may pass control of the IR light source 114 and the imager 112 to a software application or a website via an application programming interface (API) or other software interface so that the software application or website can control the imager 112 and IR light source 114 to obtain the desired IR light image.

After the IR flash is triggered, at block 410 the controller 314 controls the imaging sensor 212 to capture an IR light image with the intent that the captured image represent a reflection of the IR flash off of the user's iris or other feature. After capturing the IR light image, at block 412 the controller 314 resets the electrochromic filter 214 to the IR blocking state via the voltage signal 336 so as to return the user device 100 back to the visible light mode. Alternatively, multiple IR light images may be captured before returning the user device 100 back to the visible light mode. The method 400 then returns to block 404 to await the next user authentication event or image capture event.

Concurrently, at block 414 the user device 100 initiates an iris recognition process or other image-based biometric recognition process using the captured IR light image. In some embodiments, the iris recognition process is performed by the user device 100 using, for example, a local database of user iris information. In other embodiments, such as when the user authentication is requested by a remote server or other remote device, the user device 100 may transmit the captured IR light image to the remote device, which in turn performs the iris recognition process.

At block 416, the user device 100 or remote device determines whether the user has been authenticated based on the iris recognition process. In the event that the user is not properly authenticated, at block 418 the user is denied access to the information or functionality protected by the user authentication process. Otherwise, in the event that the user is authenticated, at block 420 the user device 100 or remote device permits the user to access the secured information or specified functionality.

Returning to block 404, in the absence of a user authentication event, the user device 100 remains in the visible light mode, and the user device 100 monitors for an image capture event at block 422. An image capture event can include, for example, a user manipulating the user device 100 to capture a photo image or to initiate capture of video imagery using the imager 112. In response to detecting an image capture event, at block 424 the controller 314 controls the imaging sensor 212 to capture one or more visible light images. Because the electrochromic filter 214 is by configured to the IR blocking filter state, the captured imagery primarily includes electromagnetic energy in the visible light spectrum. Accordingly, at block 426 the user device 100 processes the captured imagery as normal visible light imagery, such as by storing the captured visible light imagery as a photo image or video, display the captured visible light imagery at the display 108, transmitting the visible light imagery to a remote device, and the like.

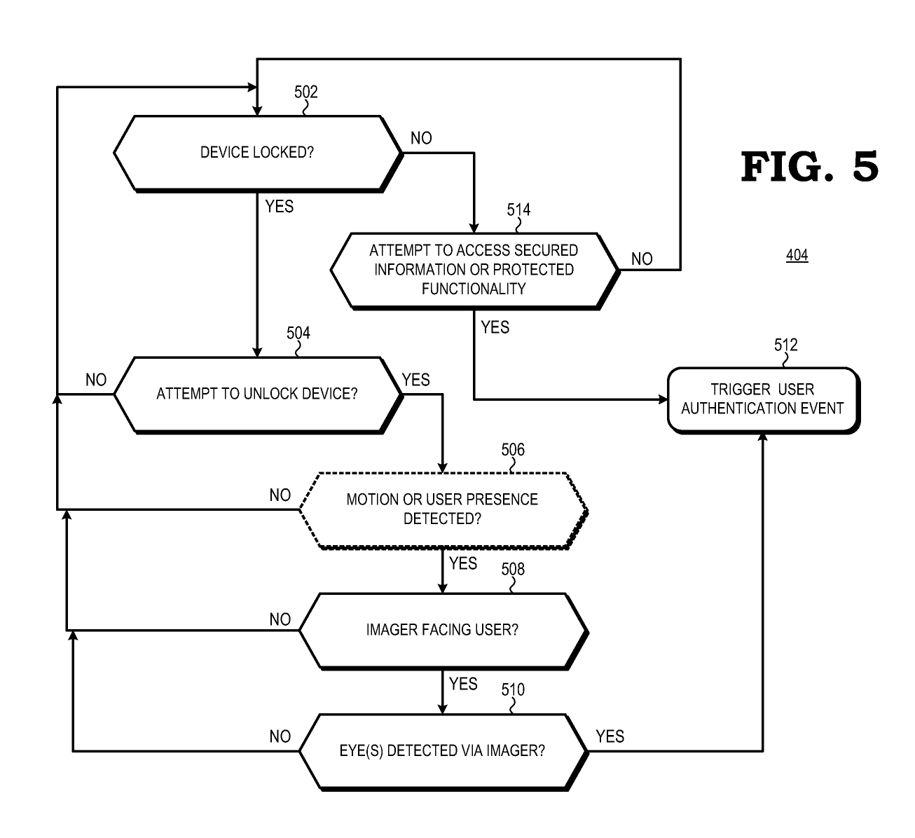

FIG. 5 illustrates an example implementation of the process of block 404 of method 400 of FIG. 4 for detecting user authentication events at the user device 100 in accordance with at least one embodiment. As noted above, the detection of a user authentication event triggers the capture of an IR light image for use in authenticating a user. False detection of user authentication events thus can result in unnecessary IR light image captures, which waste energy and processing resources of the user device 100. Accordingly, the example implementation of the user authentication event detection process of block 404 seeks to reduce falsing (that is, false detection of user authentication events).

The user authentication event detection process initiates at block 502 with the user device 100 checking whether the user device 100 is currently secured, or “locked”, from user access. To illustrate, many user devices use a login screen or passcode screen to obtain a password or passcode from a user before permitting access to the main functionality of the device. In the event that the user device 100 is locked, at block 504 the user device 100 determines whether there is an apparent attempt to unlock the user device 100. If not, the method returns to block 502.

Otherwise, if there is an apparent attempt to unlock the user device 100, the user device 100 determines whether the apparent attempt is an actual user attempt or a falsely detected attempt, such as one inadvertently caused by the user's particular grip on the user device 100. In response to an apparent unlock attempt, at block 506 the user device 100 uses feedback from one or more sensors to detection motion of the user device 100 or other indicia of user presence, which would support an inference that the apparent attempt is an actual user attempt. This feedback may include, for example, indicators of motion of the user device 100 based on movement indicated by sensor feedback from the accelerometer 326 (FIG. 3), the gyroscope 328 (FIG. 3), or the GPS receiver 330 (FIG. 3). In the event that no motion or user presence is detected, the method returns to block 502.

Otherwise, if motion or user presence is detected, at block 508 the user device 100 determines whether the imager 112 is facing the user, thereby determining the actual utility of attempting to capture an IR light image of the user's iris. The user device 100 may make this determination by, for example, application of one or more facial recognition processes to visible light imagery captured via the imager 112. If the user device 100 determines that the imager 112 is not facing the user, the method returns to block 502. Otherwise, with confirmation that the imager 112 facing the user, at block 510 the user device 100 verifies that at least one of the user's eyes is present in imagery captured via the imager 112. The presence of an eye likewise may be detected through application of facial detection processes or other object recognition processes well known in the art. If no eye is detected, the method returns to block 502.

If an eye is detected at block 510, the user device 100 has confirmed that the attempt to access the user device 100 was made with the user present, facing the imager 112, and in a manner permitting the user's iris to be captured, and thus at block 512 the user device 100 triggers a user authentication event, which, as described above, initiates the process of converting the imager 112 to an IR light mode for the purpose of capturing one or more IR light images for use by a user recognition process.

Returning to block 502, if it is determined that the user device 100 is unlocked, at block 514 the user device 100 monitors the user's interaction with the user device 100 for actions that typically trigger a request to authenticate the user, such as an attempt by the user to access local secured information on the user device 100 or remote secured information at another device, an attempt by the user to access a locked software application or locked functionality in a software application, and the like. Because these actions typically are performed using the display 108 and are difficult for the user to perform unless the user is facing the imager 112 (as the imager 112 is on the same surface as the display 108), in the event that such action is detected the user device 100 may infer that the criteria of the user being present and facing the imager 112 are met. Accordingly, in response to an action associated with an attempt to access locked information or locked functionality, the method flows to block 512 and the user device 100 triggers a user authentication event as described above.

Much of the inventive functionality and many of the inventive principles described above are well suited for implementation with or in software programs or instructions and integrated circuits (ICs) such as application specific ICs (ASICs). It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts within the preferred embodiments.

It will be appreciated that the methods and the user interface device described herein may include one or more conventional processors and unique stored program instructions that control the one or more processors or other processing components, to implement, in conjunction with certain non-processor circuits, some of the functions of the user interface device described herein. The non-processor circuits may include, but are not limited to, wireless transmitter and receiver circuits, signal drivers, clock circuits, power source circuits, sensor circuits, and the like.

In this document, relational terms such as first and second, and the like, may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element. The term “another”, as used herein, is defined as at least a second or more. The terms “including” and/or “having”, as used herein, are defined as comprising. The term “coupled”, as used herein with reference to electro-optical technology, is defined as connected, although not necessarily directly, and not necessarily mechanically. The term “program”, as used herein, is defined as a sequence of instructions designed for execution on a computer system. A “program”, or “computer program”, may include a subroutine, a function, a procedure, an object method, an object implementation, an executable application, an applet, a servlet, a source code, an object code, a shared library/dynamic load library and/or other sequence of instructions designed for execution on a computer system.

The specification and drawings should be considered as examples only, and the scope of the disclosure is accordingly intended to be limited only by the following claims and equivalents thereof. Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

What is claimed is:

1. A device comprising:
an infrared light source;
an imaging sensor;
an electrochromic filter overlying the imaging sensor, the electrochromic filter configurable between at least a first filter state and a second filter state, the second filter state having a higher infrared light transmittance than the first filter state; and
a controller to reconfigure the electrochromic filter from the first filter state to the second filter state responsive to a user authentication event.

2. The device of claim 1, wherein the user authentication event includes a user attempt to access functionality of the device.

3. The device of claim 1, wherein the user authentication event includes a user attempt to access secured information.

4. The device of claim 1, further comprising:
a processing component to process a visible light image captured by the imaging sensor while the electrochromic filter is in the first filter state.

5. The device of claim 1, further comprising:
a processing component to trigger the infrared light source to emit infrared light and to process an infrared light image captured by the imaging sensor, the infrared light image including a reflection of the emitted infrared light.

6. The device of claim 5, wherein the processing component is to process the infrared light image by performing a user recognition process using the infrared light image.

7. The device of claim 5, wherein the processing component further is to transmit the infrared light image to a remote device for user recognition processing.

8. The device of claim 1, wherein the electrochromic filter includes a bi-stable nanocrystal film.

9. The device of claim 1, further comprising:
at least one sensor; and
a processing component to verify the user authentication event responsive to feedback from the at least one sensor confirming a presence of a user.

10. A method comprising:
in response to a user authentication event at a device:
reconfiguring an electrochromic filter overlying an imaging sensor of the device from an infrared blocking state to an infrared transmitting state;
triggering an infrared light source of the device to emit infrared light;
capturing an image at the imaging sensor through the electrochromic filter while the electrochromic filter is in the infrared transmitting state; and
performing a user recognition process using the image.

11. The method of claim 10, further comprising:
detecting the user authentication event in response to at least one of: an attempt to access functionality of the device; an attempt to access secured information at the device; and an attempt to access, via the device, secured information at a remote device.

12. The method of claim 10, wherein the user authentication event includes at least one of: an attempt to unlock access to the device; and an attempt to unlock access to a software application of the device.

13. The method of claim 10, wherein the user authentication event includes an attempt to conduct an electronic commerce transaction via the device.

14. The method of claim 10, wherein:
reconfiguring the electrochromic filter from the infrared blocking state to the infrared transmitting state includes reconfiguring a voltage signal supplied to the electrochromic filter from a first voltage level to a second voltage level.

15. The method of claim 10, further comprising:
configuring a default state of the device to include setting the electrochromic filter to the infrared blocking state.

16. A method comprising:
in a first mode of a device:
configuring an electrochromic filter of the device positioned over an imaging sensor of the device to an infrared blocking state; and
capturing a visible light image via the imaging sensor; and
in a second mode of the device:
configuring the electrochromic filter to an infrared transmitting state; and
capturing an infrared light image via the imaging sensor; and
switching the device from the first mode to the second mode responsive to a user authentication event.

17. The method of claim 16, further comprising:
performing a user recognition process using the infrared light image.

18. The method of claim 17, wherein the user recognition process includes an iris recognition process.

19. The method of claim 17, further comprising:
displaying the visible light image at a display component of the device.

20. The method of claim 16, further comprising:
detecting the user authentication event as at least one of: an attempt to access functionality of the device; an attempt to access local secured information at the device; and an attempt to access remote secured information via the device.
